(19) United States
(12) Patent Application Publication
(10) Pub. No.: US 2019/0003253 A1
(43) Pub. Date: Jan. 3, 2019

(54) Sentry and method of installation thereof

(71) Applicant: Southeastern Metals Manufacturing Company, Inc., East Aurora, NY (US)

(72) Inventor: James W. Horton, Yulee, FL (US)

(21) Appl. No.: 16/002,842

(22) Filed: Jun. 7, 2018

Related U.S. Application Data
(60) Provisional application No. 62/526,898, filed on Jun. 29, 2017.
(60) Provisional application No. 62/546,180, filed on Aug. 16, 2017.
(60) Provisional application No. 62/559,044, filed on Sep. 15, 2017.

(51) Int. Cl. E06B 9/54; E06B 9/68; E06B 9/58

(52) U.S. Cl. CPC E06B 9/54; E06B 2009/527; E06B 9/58; E06B 9/68

(57) ABSTRACT

Sentry systems and methods of installation. The method comprising the following steps. First, the cassette is attached to cassette box and a plurality of holes are drilled in cassette box for attachment to wall by using a plurality of fasteners. Support angles are attached to cassette box, the support angles have preinstalled roller tube end brackets. One end of the roller tube end bracket is attached to idle gudgeon. Other end of the roller tube end bracket is attached to motor. An idle gudgeon is installed to one end of roller tube. Roller tube is attached to roller tube end bracket. Roller tube is pushed towards idle gudgeon to collapse idle bearing. Other end of the roller tube is allowed to spring forward into the roller tube end bracket having motor. Motor retaining clips are installed to retain the motor. Side rails are installed at ends of the cassette box.

### TECHNICAL FIELD

This application claims priority to provisional patent application 62/526,898 filed Jun. 29, 2017 which is incorporated by reference herein in the entirety. The invention generally relates to a field of sentry installation and, more particularly, the invention relates to a sentry and method of installation thereof.

### BACKGROUND

Retractable screens are flexible screen that retracts and rolls up into a housing attached to the edge of the porch, door or window. Retractable screens for doors and windows have been available for years and many variations are currently on the market. These screens typically include a frame that is added on to an existing doorway or window, either on the interior or the exterior. Some are self closing, including spring or pulley systems for pulley systems for power, and some are motorized for remote and/or automatic operation.

The retractable screen is retracted and becomes virtually invisible when not in use thus the fabric is protected from harmful UV rays, dirt and weather, therefore it significantly outlast the traditional flat screen. There is no need to remove and store away the screens in the winter. With retractable screens, homeowner can enjoy the view through the window or door clearly, rather than an obscured vision with traditional screen. The retractable screens are used to control the brightness, temperature, blocks harmful UV rays and prevent the entry of dirt and insects. Therefore, they provide a combination of convenience, ventilation, and protection.

Currently there are small and medium retractable screens available in market are used on doors and windows. The Large Sentry uses a larger roller tube and drop bar than the medium and small sentry units, it is difficult to match seams and the moving speed of mixed units. Therefore, there is a need to develop a method to install large sentry.

### SUMMARY OF THE INVENTION

The invention overcomes the above problem by introducing a method to install large sentry. The method provides hassle free installation particularly easy smooth rolling down of screen and retraction.

In view of the foregoing, an embodiment herein provides a sentry and method of mounting thereof.

An embodiment herein provides a method of mounting sentry. The method comprises following steps. Firstly the cassette is attached to cassette box and a plurality of holes are drilled in cassette box for attachment to wall by using a plurality of fasteners. Support angles are attached to cassette box, the support angles have preinstalled roller tube end brackets. One end of the roller tube end bracket is attached to idle gudgeon. Other end of the roller tube end bracket is attached to motor. An idle gudgeon is installed to one end of roller tube. Roller tube end having idle gudgeon is attached to roller tube end bracket. Roller tube is pushed towards idle gudgeon to collapse idle bearing. Other end of the roller tube is allowed to spring forward into the roller tube end bracket having motor. The roller tube end bracket retains roller tube. Motor retaining clips are installed to retain the motor. Side rails are installed at the ends of cassette box. Side rails are predrilled. Screen operation is checked and readjusts if the upper limit have fall bar hitting zipper funnel. Cassette cover is installed using a plurality of screws and cap assemblies. Plastic caps are placed on the plurality of holes outside of the side rails.

In one of the embodiment, spacing for bracket is between 1 to ¾ inches down from top. In an embodiment, the rails are secured at maximum 2 feet. In another embodiment, a plurality of holes are made from outside edge of rail, each hole is inches in diameter. In an embodiment, 11/32 inches drill is made on surface of side rail to accommodate plastic caps. In another embodiment, up limit of screen is 3 inches down and bottom limit is 3 inches up. In an embodiment, a hole of ⅛ inches is required to install cassette cover.

An embodiment herein describes a sentry. The sentry comprises a cassette box, a cassette ends, a roller tube end brackets, a roller tube, an idle gudgeon, two-piece drop bar, an idle bearing and a retractable screen. The cassette box is attached to wall by using a plurality of screws. The cassette ends are attached to cassette box by a plurality of screws. The roller tube end brackets are attached to cassette ends by using a plurality of fasteners. The roller tube is connected to the roller tube end brackets. The idle gudgeon is installed in roller tube ends. The sides rails are provide adjustable retractable screen tensioning and vertical adjustment alignment. The two-piece drop bar provides horizontal adjustment alignment and door sill plate provides opening sweep adjustment. The retractable screen is rolled on the roller tube. The size of the screen is 26 feet wide and 16 feet in height.

In an embodiment, the distance brackets are attached to sentry in case of distance mounting. In another embodiment, U channels comprising a rail. The rail further comprising of floating zipper track with sealing lips and continuous loop zipper. In another embodiment, the sealing lip and continuous loop zipper seals the sentry with continuous binding keeping pests and other unwanted substances away from open area.

In an embodiment, the rail is provided with a removable rail cover that allows access for maintenance without the hassle of disassembling the entire unit. In another embodiment, the screen is provided with perfect bottom seal by ¾ inch weatherproof brush.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

FIG. 1 is a flow diagram illustrating a method of mounting sentry.

FIG. 2 describes a sentry parts;

FIG. 3 describes attachment of one end of roller tube end to one end of roller tube end bracket;

FIG. 4 describes the attachment of other end of roller tube end to other end of roller tube end bracket;

FIG. 5 describes a cassette with side rails;

FIG. 6 describes an internal structure of side rails;

FIG. 7 describes a systematic diagram of large sentry drive assembly;

FIG. 8 describes a side U channels assembly; and

FIG. 9 describes different types of mounting methods.

### DETAILED DESCRIPTION OF PREFERRED EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein

The embodiments herein achieve this by providing a method of installation of retractable screen.

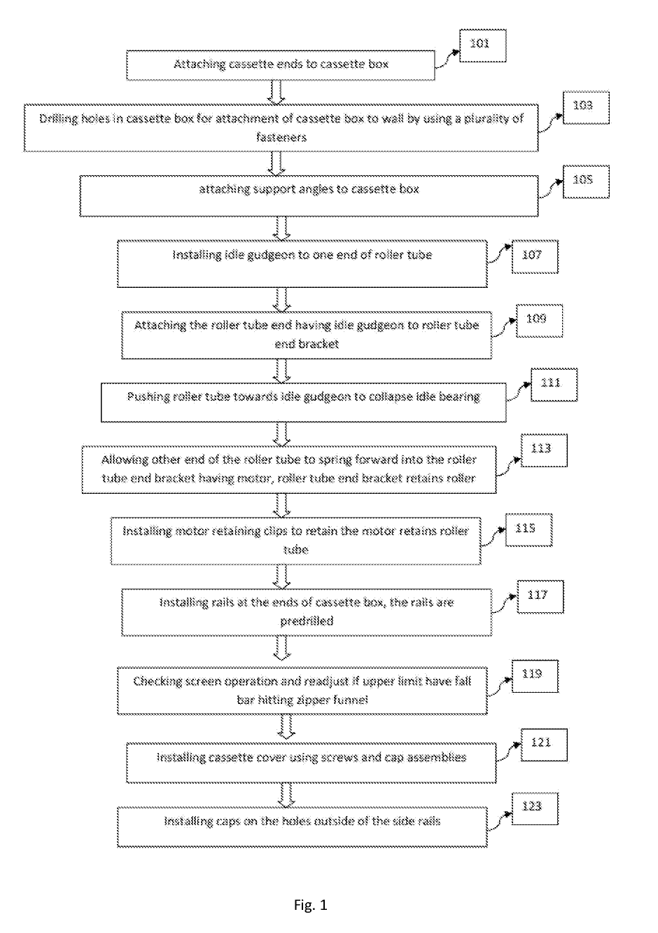

FIG. 1 describes a method of mounting retractable screens. The method comprises following steps. In step 101 cassette ends are attached to a cassette box. In step 103 a plurality of holes are drilled in cassette box to attach the cassette box to wall by using a plurality of fasteners. In step 105 support angles are attached to cassette box. The support angles have preinstalled roller tube end brackets. One end of the roller tube end bracket is attached to idle gudgeon and other end of the roller tube end bracket is attached to motor. In step 107 an idle gudgeon is installed to one end to roller tube. In step 109 roller tube ends having idle gudgeon is attached to roller end bracket. In step 111 the roller tube is pushed towards idle gudgeon to collapse idle bearing. In step 113 other end of the roller tube is allowed to spring forward into the roller tube end bracket having motor. The roller tube end bracket retains the roller tube. In step 115 motor retaining clips are installed to retain the motor. In step 117 side rails are installed at the end of cassette box. The side rails are predrilled. In step 119 slide funnel is guided onto continuous loop zipper and side rails are guided up to cassette box. In step 121 screen operation are checked and adjusted if upper limit have fall bar hitting zipper funnel. In step 123 cassette cover is installed using screws and cap assemblies.

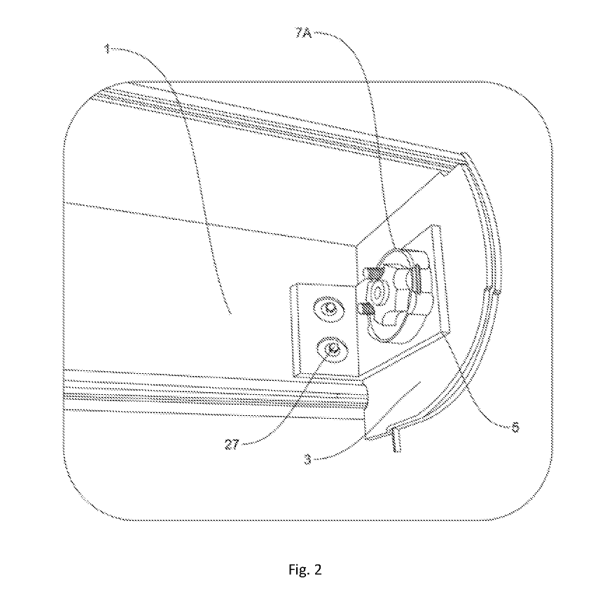

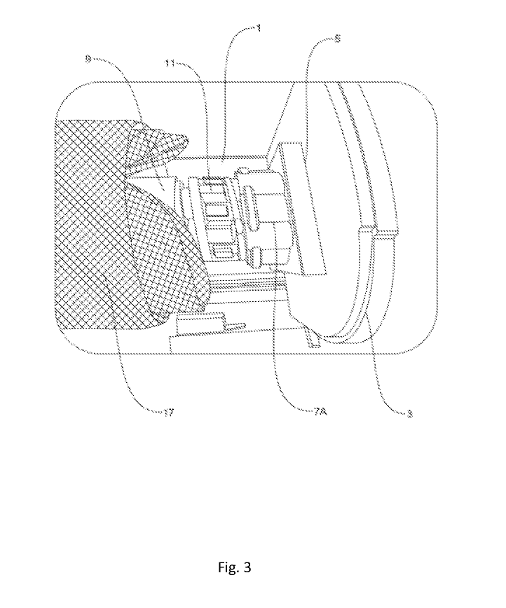

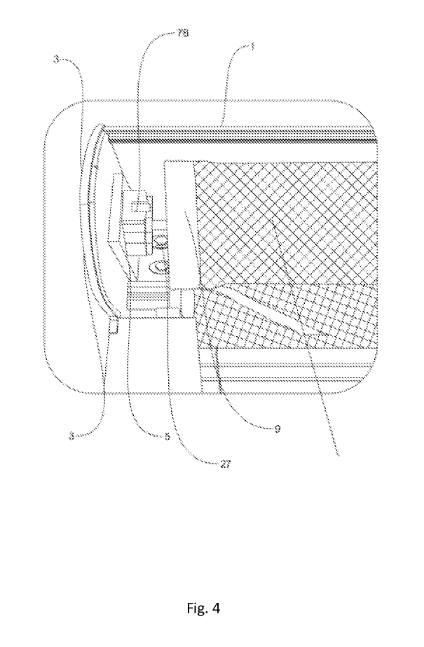

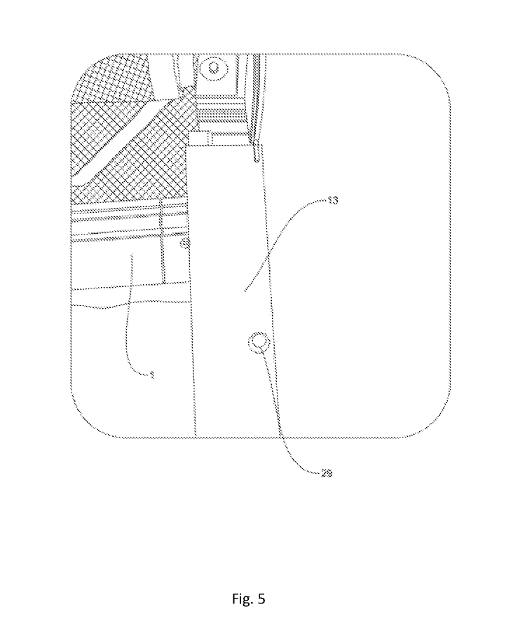

FIG. 2, FIG. 3, FIG. 4 and FIG. 5 describes sentry. The sentry comprises a cassette box 1, cassette ends 3, support angles 5, roller tube end brackets 7A and roller tube end bracket 7B, roller tube 9, idle gudgeon 11, side rails 13, two side U channels 15 a screen 17, fasteners 27 and plastic caps. The cassette box 1 is attached to wall with a plurality of fasteners 27. The cassette ends 3 are attached to cassette box by a plurality of screws. Support angles 5 are predrilled and pre slotted for bolt alignment. The support angle 5 is attached to cassette box 1. One end of roller tube end bracket 7A is attached to idle gudgeon and other end of roller tube end bracket 7B is attached to motor. One end of the roller tube is attached to idle gudgeon, and other end of the roller tube is attached to the motor. Idle bearings connect idle gudgeon to roller tubes. Side rails provide adjustable screen tensioning and vertical adjustment alignment. Two side U channels are attached to screen rod to allow tension horizontal adjustment. Zipper is used for sealing of screen to side rails. Two-piece drop bar provides horizontal adjustable alignment and door sill plate opening sweep adjustment. Slide fall bar extruded to mimic colonial base molding. Sealing lip seals the screen. Rail cover is provided that allow access for maintenance without the hassle of disassembling or dismounting the entire unit. The maximum size of the screen is 26 feet wide and 16 feet in height.

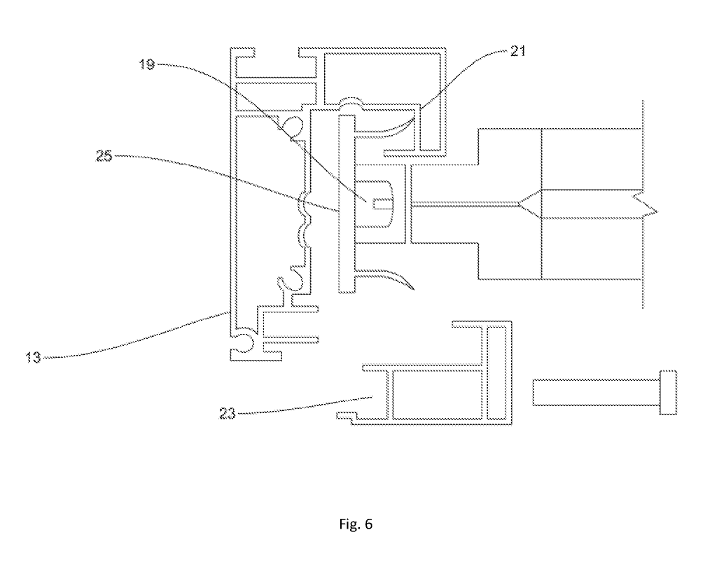

FIG. 6 describes an internal structure of side rails. The Side rail 13 comprises continuous loop zipper 19, sealing lip 21, rail front cover 23, and floating zipper track 25.

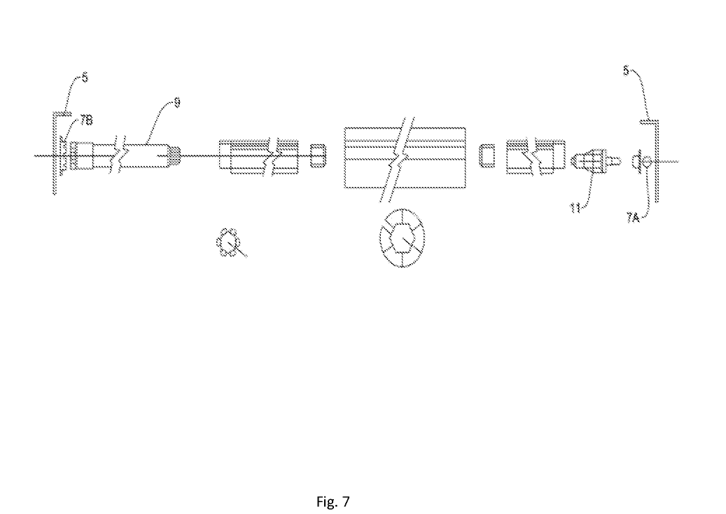

FIG. 7 describes a systematic diagram of large sentry drive assembly. The roller tube end brackets 7A and 7B are attached to support angles. The roller tube is attached to roller tube end bracket on both sides. One end of roller tube end bracket 7A is attached to idle gudgeon and other end of roller tube end bracket 7B is attached to motor.

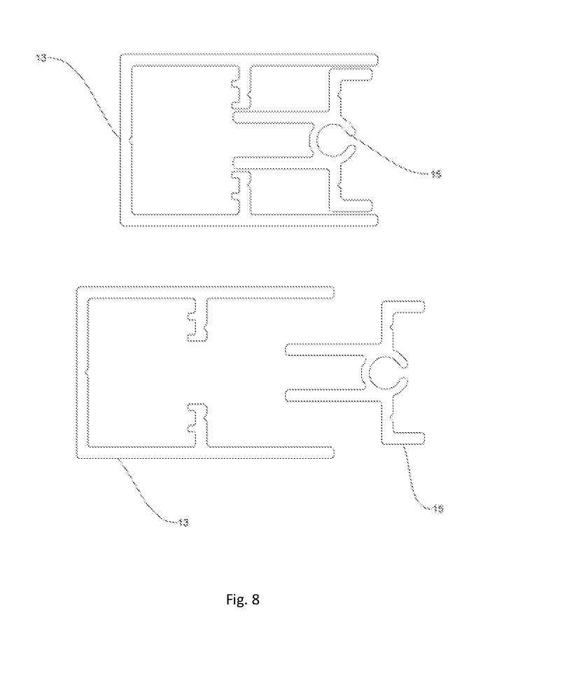

FIG. 8 describes a side U channels 15 assembly. The side rails 13 are attached to U channels 15. The screen end rod is attached to this U channel 15.

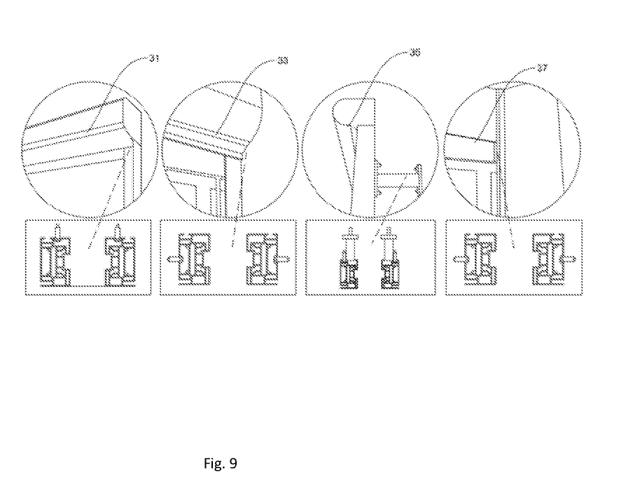

FIG. 9 describes different types of mounting methods. The four types of surface mounting 31, inside mounting 33, distance mounting 35 and recessed mounting 37. In surface mounting 31 cassettes is required. Fasteners heads for rails cannot exceed 5/16 inches diameter to use standard side rails caps. Drill of 11/32 inches is done on surface of rail to accommodate plastic caps. In inside mounting 33 cassette is not required. Roller tube is ceiling mounted, side mounted and back mounted. Side rails can be inside mount with fasteners head but not greater than ¼ deep. Inside mounting holds roller tube. In recessed mounting 37 cassette is not required. Sentry is installed on wall directly in inside and recessed mounting. In distance mounting 35 sentry is attached away from the wall. Cassette is required in distance mounting.

FIG. 4 describes schematic diagram of large size sentry drive assembly.

In an embodiment, the rails are side rails and back rails. In an embodiment, the slide fall bar is extruded in a colonial base molding. Support frame is attached to sentry in case of distance mounting. The zipper seals the screen to side rails.

In an embodiment, the side rail is secured at every 2 feet or less from. Holes are made of inches from outside edge of rail. Slide funnel is guided onto zipper and butt rail up to cassette with outside even and level. The side rail adjustment screws are tighten as needed to make screen tight. In another embodiment, Continuous loop zipper prevents broken teeth which can cause binding in the operation.

In an embodiment, a large sentry is designed for large openings that require more screen coverage then the exiting medium and small sentry units. The size of the large sentry is 26 feet wide and 16 feet in length. In another embodiment, the removable rail cover allows access for maintenance without the hassle of disassembling or dismounting the entire unit. In another embodiment, for a perfect seal a ¾ inches weatherproof brush is given.

In an embodiment, cassette dimensions are 7 inches in height and 6.75 inches in depth. Side rails are 1.5 inches wide and 2.25 inches deep. In an embodiment, the sentry is operated by remote, zipper seal and front cover.

In an embodiment, the colors of the frame are, but not limited to white, brown, beige, clay and bronze. In another embodiment the large sentry units can be installed onto the porches, windows or doors to increase privacy, control the room brightness, control temperature, blocks harmful UV rays and also prevents the entry of insects. The screens are manufactured with frames that come in variety of colours including White, Brown, Beige, Clay, Bronze. The screens can be chosen from variety of fabric styles including H (45%), J (32%), L (10%), M (10%), N (10%), p (10%) and c (5%).The fabric of the sentry screen provides customized protection like bug screen for insect protection, solar mesh for sun protection, opaque fabrics for privacy or room brightness control, or clear vinyl windows for rain and cold protection without losing the view.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

What is claimed is:

1. A method of installing sentry, the method comprising:
attaching cassette ends to a cassette box;
drilling holes in the cassette box for attachment of the cassette box to a wall by a plurality of fasteners;
attaching support angles to cassette box, wherein each of the support angles has a preinstalled roller tube end bracket, one end of the roller tube end bracket is attached to an idle gudgeon and the other end of roller tube end bracket is attached to a motor;
installing the idle gudgeon to one end of roller tube;
attaching the roller tube end having the idle gudgeon to the roller tube end bracket;
pushing the roller tube towards the idle gudgeon to collapse an idle bearing;
allowing the other end of the roller tube to spring forward into the roller tube end bracket having motor and the roller tube end bracket retains the roller tube;
installing at least one motor retaining clip to retain the motor;
installing at least one rail at the ends of cassette box, wherein the rails are predrilled;
checking screen operation and readjusting if an upper limit has a fall bar hitting a zipper funnel;
installing a cassette cover using at least one screw and at least one cap assembly; and
installing at least one cap on the at least one rail at the ends of the cassette box.

2. The method as claimed in claim 1, wherein the spacing for bracket is between 1 to ¾ inches down from top.

3. The method as claimed in claim 1, wherein the rails are secured at maximum 2 feet.

4. The method as claimed in claim 1, wherein a plurality of holes are made from outside edge of rail, each hole is ½ inches in diameter.

5. The method as claimed in claim 1, wherein an 11/32 inch drill is made on a surface of the rails.

6. The method as claimed in claim 1, wherein the screen is run up at 3 inches down and bottom 3 inches up.

7. The method as claimed in claim 1, wherein for installation of cassette cover a hole of ⅛ feet is required.

8. A sentry comprising:
a cassette box mountable to a wall by a plurality of fasteners;
at least two cassette ends attached to sides of the cassette box by a plurality of screws;
at least two support angles, wherein the support angles are predrilled and pre slotted for bolt alignment and each of the support angles is attached to the cassette box;
at least two roller tube end brackets, one end of a roller tube end bracket is attached to an idle gudgeon and the other end of the roller tube end bracket is attached to a motor;
a roller tube, wherein one end of the roller tube is attached to the idle gudgeon at one end of the roller tube end bracket, and the other end of the roller tube is attached to the motor;
an idle bearing, wherein the idle bearing connects the idle gudgeon to the roller tube;
at least two side rails, wherein the side rails provide adjustable screen tensioning and vertical adjustment alignment;
two side U channels, wherein the side U channels are attached to a screen rod and allows for tensioned horizontal adjustment;
a slide fall bar;
a continuous loop zipper;
a two-piece drop bar, wherein the two-piece drop bar provides horizontal adjustable alignment and door sill plate opening sweep adjustment; and
a screen is rolled on the roller tube, wherein the maximum size of the screen is 26 feet wide and 16 feet in height.

9. The sentry as claimed in claim 8, further comprising at least two back rails.

10. The sentry as claimed in claim 8, wherein the slide fall bar is extruded in a colonial base molding.

11. The sentry as claimed in claim 8, further comprising distance brackets attached to the sentry in a case of distance mounting.

12. The sentry as claimed in claim 8, wherein the two side U channels comprise a rail.

13. The sentry as claim in claim 12, wherein the rail is further comprised of a floating zipper track with sealing lips and a continuous loop zipper.

14. The sentry as claimed in claim 13, wherein the sealing lip and the continuous loop zipper seals the sentry with continuous binding to keep pests and other unwanted substances away from an open area.

15. The sentry as claimed in claim 8, wherein the at two side rails are provided with a removable rail cover that allows access for maintenance without disassembling the entire unit.

16. The sentry as claimed in claim 8, wherein the screen is provided with a bottom seal by ¾ inch weatherproof brush.

17. The sentry as claimed in claim 8, wherein the slide fall bar facilitates smooth downward rolling of the screen along the side rails.
